(19) United States
(12) Patent Application Publication
(10) Pub. No.: US 2018/0248203 A1
(43) Pub. Date: Aug. 30, 2018

(54) SYSTEM AND METHOD FOR MANUFACTURING CHANNELS IN A BIPOLAR PLATE

(71) Applicant: GM GLOBAL TECHNOLOGY OPERATIONS LLC, DETROIT, MI (US)

(72) Inventors: Siguang Xu, Rochester Hills, MI (US); Joseph N Lovria, Davisburg, MI (US)

(21) Appl. No.: 15/444,950

(22) Filed: Feb. 28, 2017

(51) Int. Cl. H01M 8/026; B21D 22/02; H01M 8/021

(52) U.S. Cl. CPC H01M 8/026; H01M 8/021; B21D 22/02

(57) ABSTRACT

A method for manufacturing a bipolar plate includes the steps of: (1) providing sheet metal within a stamping press system; (2) stamping the sheet metal with a first die to define an interim flat land, a first interim sidewall, a second interim sidewall, and a first interim channel depth for a plurality of flow channels; and (3) stamping the sheet metal with a second die to widen the interim flat land in each flow channel in the plurality of flow channels forming a final flat land and to reduce each interim radii of each flow channel in the plurality of flow channels. The stamping press system may, but not necessarily, include a first press station having a first die set and a second press station having a second die set wherein the second press station is applied to the sheet metal after it has been formed by the first press station.

### TECHNICAL FIELD

The present disclosure generally relates to the manufacture of a stainless steel alloy bipolar plate for use in a fuel cell environment that exhibits a significant improvement in dimensional accuracy, and more particularly to a manufacturing method to produce a stamped austenitic stainless steel bipolar plate having improved dimensional accuracy via reduced spring back and warpage.

### BACKGROUND

In many fuel cell systems, hydrogen or a hydrogen-rich gas is supplied through a flow path to the anode side of a fuel cell while oxygen (such as in the form of atmospheric oxygen) is supplied through a separate flow path to the cathode side of the fuel cell. An appropriate catalyst is typically disposed to form on these respective sides: an anode to facilitate hydrogen oxidation and a cathode to facilitate oxygen reduction. From this, electric current is produced with high temperature water vapor as a reaction by-product.

The interior cells of the stacked assembly comprise one side of each of two opposing bipolar plates. The facing bipolar plates enclose cell elements comprising a proton exchange membrane-electrode assembly, gaskets, gas diffusion media, and the like. Each bipolar plate is formed of two like-shaped plates, in face-to-face arrangement, that have gas flow passages on their external faces and internal coolant passages defined by their inverse and facing sides. As shown in the example bipolar plate of FIG. 1, one side of a first bipolar plate provides passages for the flow of hydrogen to the anode side of the membrane-electrode assembly and one side of a second, opposing bipolar plate provides passages for the flow of air to the cathode side of the membrane-electrode assembly. Heat is produced in the operation of the stack of cells and coolant flow through the interior of the bipolar plates is used to cool the stack, particularly the internal cells of the stack.

A bipolar plate is typically stamped from a thin, generally rectangular sheet of metal and, preferably, each sheet is of generally the same shape. Because the bipolar plate operates in a high temperature and corrosive environment, it is preferable to manufacture the bipolar plates from stainless steel given their desirable corrosion-resistant properties. Moreover, in situations where cost of fuel cell manufacture is an important consideration, metal-based bipolar plates may be preferable to other high-temperature, electrically conductive materials, such as graphite, in addition to being relatively inexpensive, stainless steel plates can be formed from relatively thin sheet metal (for example, between less than 0.1 and 1.0 millimeters in thickness).

It is also understood when subjected to a one-step stamping approach, austenitic stainless steel may incur early necking and fracture particularly where the draw depth is comparatively large in the one-step approach. Moreover, using a one-step stamping approach, austenitic stainless steels are also particularly subject to demonstrating lateral springback in the region having flow channels and metal bead channels such that the bipolar plate may have a varying width along the length of the plate. Warpage may also occur in the bipolar plate due to the lateral spring back in the regions having channels.

To improve the formability of thin stainless steel sheet, it is known that a hydro-forming process could be used. Nevertheless, such a process is slow, and requires expensive special equipment that would make it hard to meet either the required production rate or production cost Likewise, electro-magnetic forming could be used, but is a process that is still under development and not suitable for low-cost mass production.

The above information disclosed in this Background section is only for enhancement of understanding of the background of the invention, and therefore, it may contain information that does not form the prior art that is already known in this country to a person of ordinary skill in the art. Accordingly, there is a need for a manufacturing method which is cost-effective, time efficient and could produce bipolar plates having improved dimensional accuracy with reduced lateral spring-back.

### SUMMARY

The present disclosure provides a method for manufacturing a bipolar plate includes the steps of: (1) providing sheet metal within a stamping press system; (2) stamping the sheet metal with a first die to define an interim flat land, a first interim sidewall, a second interim sidewall, and a first interim channel depth for a plurality of flow channels; and (3) stamping the sheet metal with a second die to widen the interim flat land in each flow channel in the plurality of flow channels forming a final flat land and to reduce each (upper and/or lower) radii of each flow channel in the plurality of flow channels.

One embodiment of a stamping press system according to the present disclosure includes a first stamping press having a first die set and a second stamping press having a second die set wherein the second stamping press is applied to the sheet metal after it has been formed by the first stamping press

Another embodiment of a stamping press system may be provided which includes a first stamping press (or press station) and a second stamping press (or press station)for use after the first stamping press (or press station). The first stamping press (or press station) includes a first die set, the first die set being operatively configured to define a plurality of flow channels in a piece of sheet metal wherein an interim channel depth, an interim first sidewall, an interim second sidewall, an interim sidewall orientation, an interim flat land, and an interim radius are formed in each flow channel in the plurality of flow channels. The second stamping press (or press station) may be operatively configured to receive the sheet metal after it has been deformed in the first stamping press (or press station). The second stamping press (or press station) includes a second die set, where the second dies set may be operatively configured to plastically form a final sidewall orientation, a final flat and, and a final radius from the interim sidewall orientation, the interim flat land, and the interim radius in each flow channel in the plurality of flow channels.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 is an expanded view of a bipolar plate formed from two stamped austenitic stainless steel shells.

FIG. 2A illustrates a cross section of a channel (flow channel or metal bead) formed via a first die into sheet metal in accordance with multiple embodiments of present disclosure.

FIG. 2B illustrates a cross section of the channel from FIG. 2A after it has been stamped via a second die in accordance with multiple embodiments of present disclosure.

FIG. 3 is a flow chart which illustrates a method to manufacture a bipolar plate in accordance with multiple embodiments of the present disclosure.

FIG. 4 is a bar graph which illustrates example data which demonstrates how the lateral spring back is significantly reduced via the manufacturing method and system of the present disclosure.

FIG. 5A illustrates various example dimensions of example channels of FIG. 2A (flow channels and/or metal bead) which relate to the manufacturing method and system of the present disclosure.

FIG. 5B illustrates various example dimensions of example channels of FIG. 2B (flow channels and/or metal bead) which relate to the manufacturing method and system of the present disclosure.

FIG. 6 illustrates a first embodiment stamping press system according to the present disclosure

FIG. 7 illustrates a second embodiment stamping press system according to the present disclosure.

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors, The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by length; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, un-recited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

In light of the detailed features (flow channels) which must be manufactured into a bipolar plate, current bipolar plate manufacturing accounts for a high portion of overall fuel cell stack cost. While using stamped stainless steel bipolar plates would be beneficial in addressing a significant portion of this cost, the low formability of stainless steel in general is a significant challenge in producing bipolar plates. This challenge occurs due to the fact that the manufacturing process involves stamping very thin (for example, 0.100 millimeters or thinner) sheets which must possess the required channel strength and depth to satisfy functional requirements.

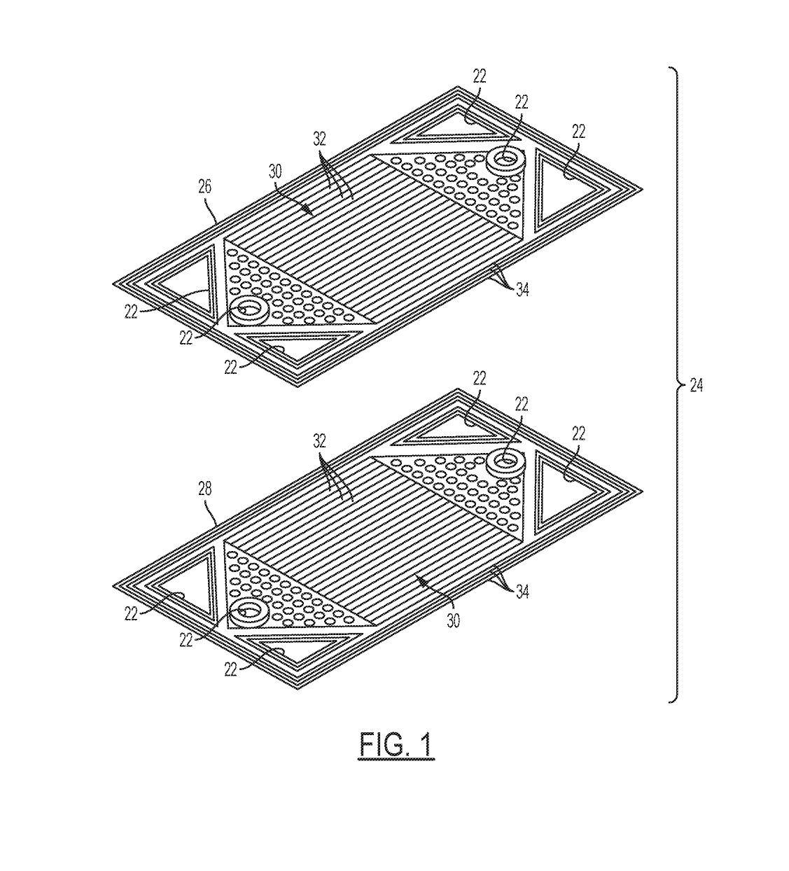

With reference to FIG. 1, a bipolar plate 24 is shown in an expanded view where a first sheet 26 and a second sheet 28 are shown apart. It is understood that, in forming bipolar plate 24, the first sheet 26 and the second sheet 28 are joined together so that the flow channels 32 and metal beads 34 from each sheet 26, 28 are mated together. Opposing edges 20 at the short sides of each sheet 26, 28 define shaped apertures, respectively, for the inlet and exit of fuel, oxidant, and coolant. It is understood that in the assembly of a fuel cell stack, each bipolar plate is intended to form a part of two adjacent cells, one cell on each outer face of the bipolar plate. One outer face (first sheet 26) of a bipolar plate provides an anode plate for one cell and the other outer face (second sheet 28) provides a cathode plate for the adjacent cell.

As shown in FIG. 1, the central portion 30 of each sheet 26, 28 is shaped with spreading flow channels 32 for gas flow from the inlet, channels for distributed flow of gas over the membrane, and converging channels for directing gas to the exit. As noted, when two such sheets 26, 28 are suitably bonded with gas flow passages facing outwardly to form a bipolar plate, the inverse sides of the stamped sheets provide flow-controlling passages (via flow channels 32) for the coolant. These flow controlling passages for the coolant should ideally have uniform cross sections. Moreover, the gas flow passages as well as the metal beads 34 should also ideally have uniform cross sections. However, when austenitic stainless steel is used as material for the sheet metal 26, 28, the depth across the flow channels 32 (and resulting cross section for each flow controlling passage) may vary due to spring back of the material where the channels are formed. Moreover, the depth across the metal beads (and resulting cross section for each metal bead) may also vary due to spring back in the stamped metal beads.

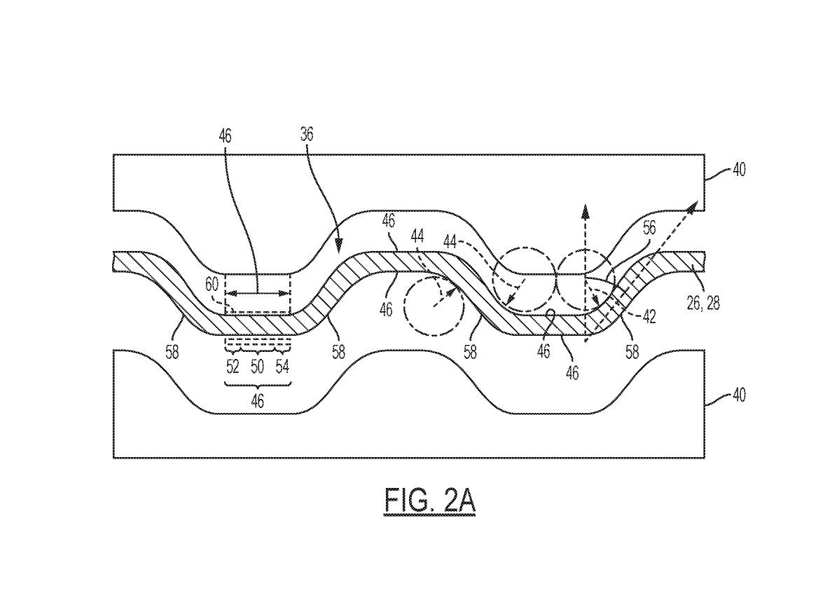

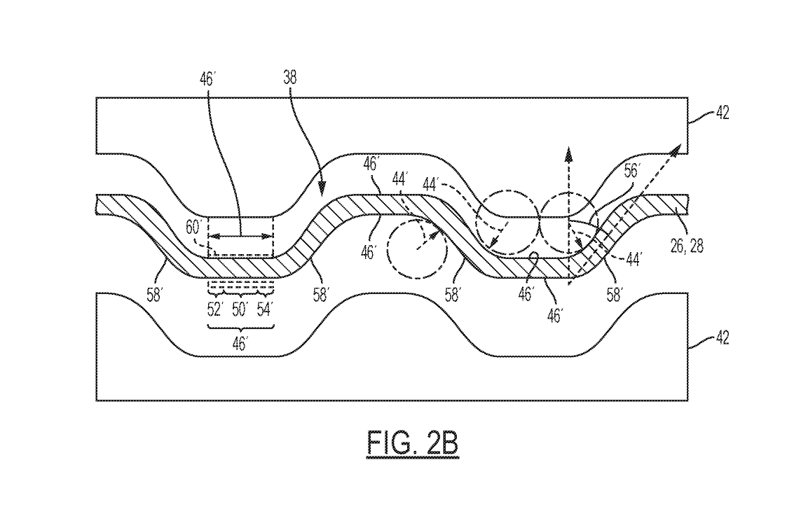

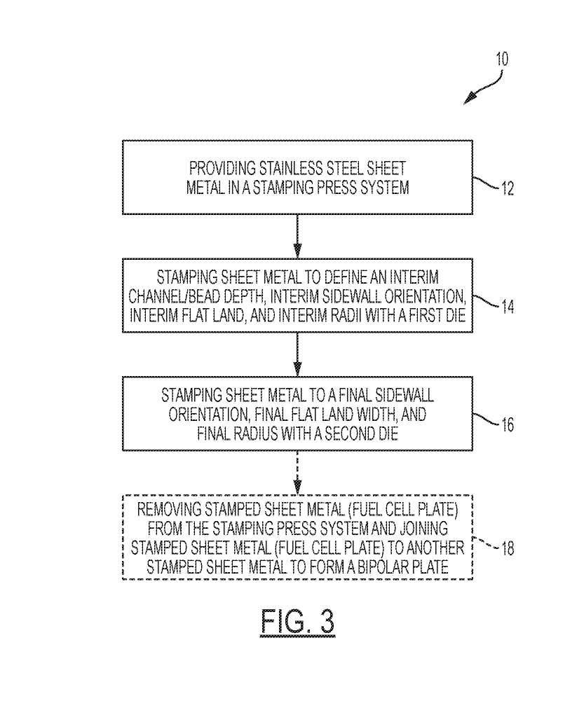

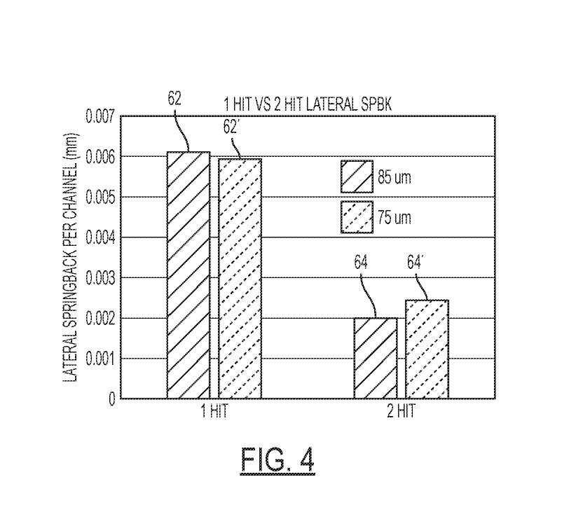

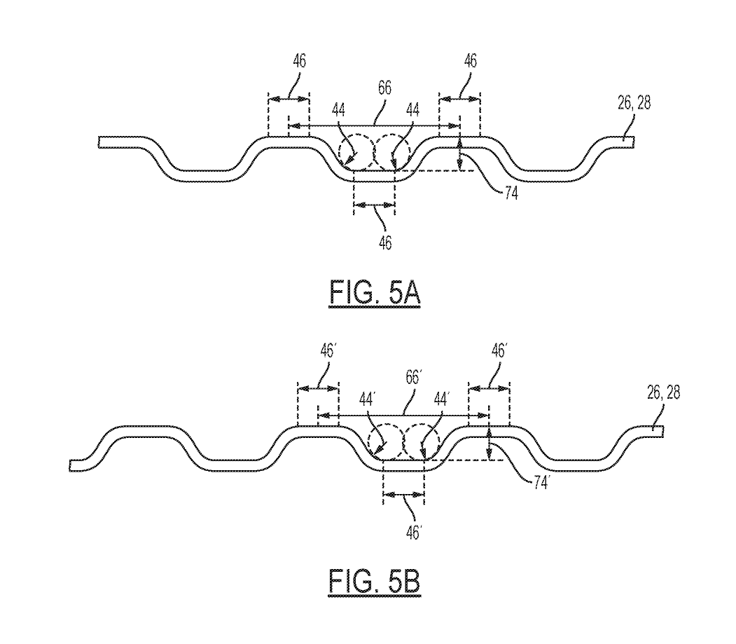

Referring now to FIG. 3, a flow chart is shown which illustrates one non-limiting example method 10 for manufacturing a bipolar plate in accordance with multiple embodiments of the present disclosure. As shown, an example non-limiting method 10 may include the steps of: (1) providing a piece of sheet metal within a stamping press system; 12 (2) stamping the piece of sheet metal with a first die set to define an interim flat land, a first interim sidewall, a second interim sidewall, and a first interim channel depth for a plurality of flow channels; 14 and (3) stamping the piece of sheet metal with a second die to widen the interim flat land in each flow channel in the plurality of flow channels forming a final flat land 46′ and to reduce each interim radii 44 of each flow channel in the plurality of flow channels 16 resulting final radii 44′ (shown in FIG. 2B and FIG. 5B). Of course, the sheet metal may be removed from the press system via step 18 after the first and second die sets are applied to the sheet metal 26, 28. It is understood that the second die set 42 is applied to the piece of sheet metal (or “sheet metal”) 26, 28 after the sheet metal 26, 28 has been deformed by the first die set 40. While the aforementioned method 10 may be applied to various materials, it is understood that this method 10 is useful with respect to forming a plurality of channels in sheet metal 26, 28 made of austenitic stainless steel.

Referring now to FIGS. 2A-2B, and 5A-5B, schematic cross sectional views of example channels are shown. It is understood that the channels 36, 38 formed in sheet metal 26, 28 may represent either flow field channels 32 (see FIG. 1) or bead channels 34 (see FIG. 1). FIG. 2A illustrates the schematic cross sectional view of example channels formed after the first die set 40 is applied. FIG. 2B illustrates the schematic cross sectional view of example channels formed after the second die set 42 is applied to the sheet metal 26, 28. As noted in the non-limiting example method 10 above, a first die set 40 is initially applied to the piece of sheet metal 26, 28. In doing so, an interim radius 44 is formed at the base of each interim sidewall 58 of each channel in the plurality of channels 36, 38. However, as described in the process shown in FIG. 3 and shown in FIG. 2B, each flow channel is slightly altered after the second die 42 is applied to the sheet metal 26, 28.

Referring to FIG. 3, the step of stamping the piece of sheet metal 26, 28 with a second die may include the step of defining the final flat land 46′. It is understood that the piece of sheet metal may be either the first piece of sheet metal 26 or the second piece of sheet metal 28. The final flat land 46′ is shown in FIG. 2B. It is understood that the final flat land 46′ defines a width which is slightly longer/larger than the width of the interim flat land 46. The interim flat land 46 which is shown in FIG. 2A and formed via the application of the first die set as noted in FIG. 3. When the first die set stamps the sheet metal, it is understood that the first and second edge regions 52, 54 in addition to a center region 50 in the interim flat land 46 may be formed. (See FIG. 2A) However, during the step of stamping the piece of sheet metal 26, 28 with the second die set 42, it is understood that this includes the step of plastically widening the interim flat land 46 into the final flat land 46′ at the first and second edge regions 52, 54 of each interim flat land 46 in the plurality of channels 36, 38. It is understood that the interim flat land 46 increases in length by about 20% to 50% after it is stamped by the second die set 42 due to plastic deformation of first and second edge regions 52, 54 wherein the first and second edge regions are lengthened and changed to elements 52′ and 54′ in FIG. 2B. Accordingly, first and second edge regions 52′, 54′ of each channel are slightly longer relative to first and second edge regions 52, 54 of FIG, 2A.

Accordingly, the first and second edge regions 52, 52′, 54, 54′ experience plastic deformation via a load from the second die thereby widening the interim flat land 46 into a wider final flat land 46′. Again, the wider final flat land 46′ has a width that may be 20-50% greater than the width of the interim flat land 46. However it is understood that the center region 50 of the interim flat land 46 remains intact such that the center region 50 of the interim flat land 46 experiences almost no plastic deformation. Accordingly, the width of the center region 50 of the interim flat land 46 remains substantially the same when compared to the width of the center region 50′ of the final flat land 46′. It is understood that, by maintaining the structure of the center region 50 of the interim flat land 46 when stamped by the second die, no additional stretching of coating 60 on the sheet metal 26, 28 is applied thereby providing optimum bipolar plate performance against corrosion. It is understood that coating 60 is disposed across both surfaces of sheet metal 26, 28. Coating 60 is identified in a particular example region relative to an example flat land 46, 46′ for purposes of the present disclosure.

Therefore, it is understood that the interim flat land 46 and the final flat land 46′ may each include a first edge regions and a second edge region, 52, 52′, 54, 54′ (as shown in FIGS. 2A and 2B). It is also understood that the interim flat land 46 further comprises an interim flat land center region 50 and the final flat land 46′ includes a final flat land center region 50′. Each interim flat land 46 center region and each final flat land center region 50′ have substantially equal widths given the final flat land center region 50′ may be configured to be free from substantial plastic deformation when the second die is applied to the piece of sheet metal 26, 28. That is, the second die set 42 does not cause significant plastic deformation in the flat land center region 50, 50′. Therefore, the center regions 50, 50′ are substantially free from plastic deformation when the second die set is applied. However, given that the first and second edge regions 52, 52′, 54, 54′ experience plastic deformation, it is understood that each final flat land 46′ defines a final width which is greater than a width of the initial flat land 46.

Also as shown in FIG. 3, it is also understood that the step of stamping the piece of sheet metal 26, 28 with a second die may also include the step of plastically deforming the interim radius in each flow channel in the plurality of channels 36, 38 to a final radius 44′, the final radius 44′ being less than the interim radius 44. Each interim radius 44 of each flow channel is found proximate to the first and second edge regions 52, 54 of interim flat land 46 as shown in FIGS. 2A and 5A. Each final radius 44′ of each flow channel is generally less than each interim radius 44. The interim radius may therefore decrease by approximately 10% -70%.

As each interim radii 44 (shown in FIGS. 2A and 5A) decreases to the final radii 44′. it is understood that the sidewalls 58 of each channel becomes more vertical as sidewalls 58′ in FIGS. 2B and 5B. Referring to FIGS. 2A and 5A, sidewalls 58 within each channel (after the first stamping step) may be referenced as a first side wall 58′″ and a second side wall 58″1′. Similarly, the sidewalls 58′ (after the second stamping step) within each channel 58′ in FIGS. 2B and 5B may be referenced as a first side wall 58″″ and a second side wall 58″″′. Therefore, as shown in FIGS. 2A and 2B, the angle 56 of the interim sidewall (“interim sidewall orientation” 56) is generally greater than the angle 56′ of the final sidewall orientation (“final sidewall orientation” 56′). The angle 56 of the sidewall orientation decreases after the second die is applied to the sheet metal 26, 28. As a result, in applying the second die set 42 to the sheet metal 26, 28, the sidewalls 58, 58′ and the interim first and second edge regions 52, 52′, 54, 54′ experience plastic deformation when the second die set 42 is applied to the piece of sheet metal 26, 28. It is understood that interim channel pitch 66 (formed via first die set stamping) remains substantially equivalent to final channel pitch 66′ (formed via second die set stamping).

Due to the plastic deformation occurring at targeted locations in each channel 36, 38, it is understood that the dimensional variation among the channels decreases relative to the second hit. For example, after the first die set is applied, the channel height 74 (shown in FIG. 5A) may vary as much as 10-20 microns at the flow channels 32 (shown in FIG. 1) and by as much as 20-40 microns at the bead channels 34 (shown in FIG. 1). However, after the second die set is applied, the channel height 74′ (shown in FIG. 5B) may vary only as much as 0-5 microns at the flow channels 32 (shown in FIG. 1) and by only as much as 5-10 microns at the bead channels 34 (shown in FIG. 1). Accordingly, the end resulting variations of about 0-5 microns and about 5-10 microns respectively under the two step die process of the present disclosure is a significantly reduction in dimensional variability.

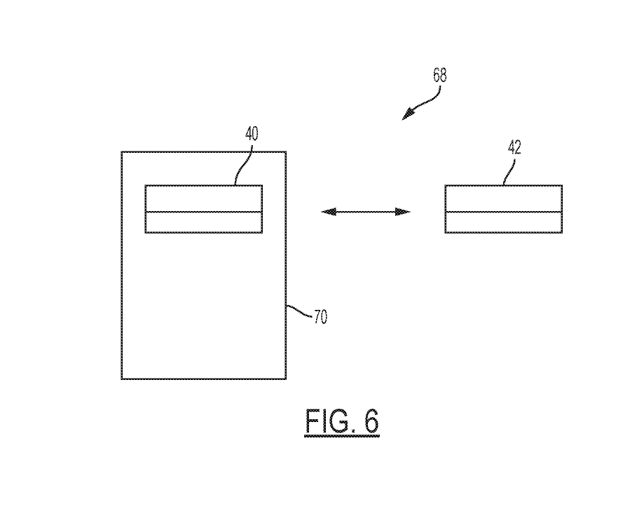

With reference to FIG. 6, a first embodiment stamping press system for manufacturing a bipolar plate 26, 28 is shown. The stamping press system may include the following: (1) a stamping press/70; (2) a first die set 40; and (3) a second die set 42. The stamping press/70 may be operatively configured to implement at least one of a plurality of die sets. Where stamping press/70 is able to receive two or more die sets at a time, a progressive die stamping process may be performed by stamping press 70 wherein the first die set is used first and then the second die set is used in sequence. The first die set 40 may be operatively configured to define a plurality of interim channels 36 (flow channels and/or metal bead channels) in a substantially planar piece of sheet metal 26, 28 wherein an interim channel depth 74, interim sidewalls 58, an interim sidewall orientation 56, an interim flat land 46, and an interim radius 44 are formed in each channel 36 in the plurality of channels 36—as shown in FIGS, 2A-2B and 5A-5B. In the event that the stamping press/70 can only hold one die set at a time, the first die set 40 may be removed and replaced by a second die set 42 for use in the stamping press 70. Accordingly, the second die set 42 may be operatively configured to be implemented in the stamping press/70 after implementing and removing the first die set 40 in the stamping press 70. As shown in FIGS. 2A-2B and FIGS. 5A-5B, the second die set 42 may be configured to plastically form a final sidewall orientation 56′, a final flat land 46′, and a final radius 44′ from the interim sidewall orientation 56, the interim flat land 46, and the interim radius 44′ in each flow channel in the plurality of channels 36, 38. The angle of the orientation 56, 56′ should be construed to be the same thing as the sidewall orientation 56, 56′.

Therefore, plastic deformation may occur in all regions of the channels 36, 38 (sidewalls 58, radii 44, edge regions 52, 54) except for the flat land center regions 50, 50′ for both the interim channels 36 and the final channels 38, As described earlier, the second die set 42 of an example system accordingly to the present disclosure may be operatively configured to plastically deform an interim first edge region 52 and an interim second edge region 54 in each flow channel 36 in the plurality of interim channels 36 while simultaneously plastically deforming the first and second sidewalls in each flow channel. As described, the second die set 42 is configured to maintain the structural integrity of the interim flat land center region 50 of each interim flow channel in the plurality of channels 36 while the second die causes plastic deformation at the first and second edge regions 52, 54 in each flow channel in the plurality of channels 36.

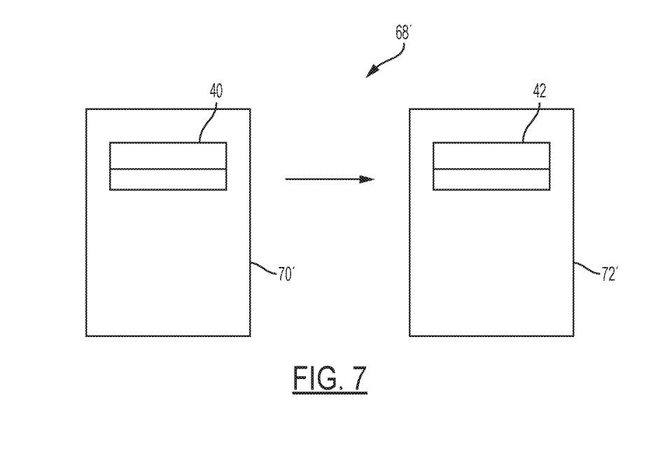

Referring now to FIG. 7, another embodiment of a stamping press system 68′ is shown. The stamping system 68′ may be provided which includes a first stamping press (or press station) 70′ and a second stamping press (or press station) 72′ for use after the first stamping press (or press station) 70′. The first stamping press (or press station) 70′ includes a first die set 40, the first die set 40 being operatively configured to define a plurality of interim channels 36 in a piece of sheet metal 26, 28 wherein an interim channel depth 74, an interim sidewall 58 on each side of the channel 36, an interim sidewall orientation 56, an interim flat land 46, and an interim radius 44 are formed in each interim channel 36 in the plurality of interim channels 36. The second stamping press (or press station) may be operatively configured to receive the sheet metal 26, 28 after it has been deformed in the first stamping press (or press station). The second stamping press (or press station) 72′ includes a second die set 42, where the second die set may be operatively configured to plastically form a final sidewall orientation 56′, a final flat land 46′, and a final radius 44′ from the interim sidewall orientation 56, the interim flat land 46, and the interim radius 44 in each channel 36 in the plurality of final channels 36. As described earlier, the interim flat land 46 formed by the first die set 40 includes an interim flat land center region 50 and the final flat land 46′ includes a final flat land center region 50′, the interim flat land 46 and the final flat land 46′ each further include first and second edge regions 52, 54, 52′, 54′ as shown in FIGS, 2A-2B).

The second die set 42 is operatively configured to plastically deform the first edge region 52 and the second edge region 54 in the interim flat land 46 of each interim channel 36 in the plurality of interim channels 36 while simultaneously plastically deforming the interim sidewalls 58 in each flow channel. Accordingly, the second die set 42 is configured to maintain the structural integrity of the interim flat land center region 50 of the interim flat land 46 of each channel 36, 38 in the plurality of channels while the second die set 42 causes plastic deformation at the first and second edge regions 52, 52′, 54, 54′ in each flow channel in the plurality of flow channels. Therefore, the interim flat land 46 defines a width 46″′ which is less than a final width 46″ of the final flat land 46′.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for manufacturing a bipolar plate, the method comprising the steps of:
providing a piece of sheet metal within a stamping press system;
stamping the piece of sheet metal with a first die to define an interim flat land, a first interim sidewall, a second interim sidewall, a plurality of interim radii for each of the first and second sidewalls, and a first interim channel depth for a plurality of flow channels; and
stamping the piece of sheet metal with a second die to widen the interim flat land in each flow channel in the plurality of flow channels forming a final flat land and to reduce each interim radii in the plurality of interim radii of each flow channel in the plurality of flow channels thereby forming a final radius.

2. The method as defined in claim 1 wherein the piece of sheet metal is formed from austenitic stainless steel.

3. The method as defined in claim 2 wherein the step of stamping the piece of sheet metal with the first die also includes the step of defining an interim radius at each flow channel in the plurality of flow channels.

4. The method as defined in claim 3 wherein the step of stamping the piece of sheet metal with a second die includes the step of defining the final flat land.

5. The method as defined in claim 4 wherein the interim flat land and the final flat land each include a first edge regions and a second edge region.

6. The method as defined in claim 5 wherein the interim flat land further comprises an interim flat land center region and the final flat land includes a final flat land center region.

7. The method as defined in claim 6 wherein the step of stamping the piece of sheet metal with a second die includes the step of plastically deforming the interim radius in each flow channel in the plurality of flow channels to a final radius, the final radius being less than the interim radius.

8. The method as defined in claim 7 wherein the step of stamping the piece of sheet metal with the second die includes the step of plastically widening the interim flat land into the final flat land at the first and second edge regions of each interim flat land in the plurality of flow channels.

9. The method as defined in claim 8 wherein an interim flat land center region and a final flat land center region have substantially equal widths wherein the final flat land center region is configured to be substantially free from plastic deformation when the second die is applied to the piece of sheet metal.

10. The method as defined in claim 9 wherein the final flat land defines a final width which is greater than a width of the initial flat land.

11. The method as defined in claim 10 wherein the first and second sidewalls and the first and second edge regions experience plastic deformation when the second die is applied to the piece of sheet metal.

12. A stamping press system for manufacturing a bipolar plate, the stamping press system comprising:
a stamping press operatively configured to implement at least one of a plurality of die sets;
a first die set operatively configured to define a plurality of flow channels in a substantially planar piece of sheet metal wherein an Interim Channel/Bead Depth, an interim first sidewall, an interim second sidewall, an interim sidewall orientation, an interim flat land, and an interim radius are formed in each flow channel in the plurality of flow channels; and
a second die set operatively configured to be implemented in the stamping press after implementing and removing the first die set in the stamping press, the second die set configured to plastically form a final sidewall orientation, a final flat land, and a final radius from the interim sidewall orientation, the interim flat land, and the interim radius in each flow channel in the plurality of flow channels.

13. The stamping press as defined in claim 12 wherein the second die set being operatively configured to plastically deform a first edge region and a second edge region in each flow channel in the plurality of flow channels while simultaneously plastically deforming the first and second sidewalls in each flow channel.

14. The stamping press as defined in claim 13 wherein the second die set being configured to maintain the structural integrity of the interim flat land center region of each flow channel in the plurality of flow channels while the second die causes plastic deformation at the first and second edge regions in each flow channel in the plurality of flow channels.

15. A stamping press system for manufacturing a bipolar plate, the stamping press system comprising:
a first press station including a first die set, the first die set being operatively configured to define a plurality of flow channels in a piece of sheet metal wherein an interim channel depth, an interim first sidewall, an interim second sidewall, an interim sidewall orientation, an interim flat land, and an interim radius are formed in each flow channel in the plurality of flow channels; and
a second press station operatively configured to receive the sheet metal after it has been deformed in the first press station, the second press station including a second die set, the second die set being operatively configured to plastically form a final sidewall orientation, a final flat land, and a final radius from the interim sidewall orientation, the interim flat land, and the interim radius in each flow channel in the plurality of flow channels.

16. The stamping press system as defined in claim 15 wherein the interim flat land includes an interim flat land center region and the final flat land includes a final flat land center region, the interim flat land and the final flat land each further include first and second edge regions.

17. The stamping press system as defined in claim 16 wherein the second die set being operatively configured to plastically deform the first edge region and the second edge region in the interim flat land of each flow channel in the plurality of flow channels while simultaneously plastically deforming the first and second interim sidewalls in each flow channel.

18. The stamping press system as defined in claim 17 wherein the second die set being configured to maintain the structural integrity of the interim flat land center region of the interim flat land of each flow channel in the plurality of flow channels while the second die causes plastic deformation at the first and second edge regions in each flow channel in the plurality of flow channels.

19. The stamping press system as defined in claim 18 wherein the interim flat land defines a width which is less than a final width of the final flat land.
